(19) United States
(12) Patent Application Publication
(10) Pub. No.: US 2003/0016482 A1
(43) Pub. Date: Jan. 23, 2003

(54) Surge gap protection circuit for use with electrical device

(76) Inventor: Stephen L. Webb, Covington, GA (US)

Correspondence Address: SCIENTIFIC-ATLANTA, INC., INTELLECTUAL PROPERTY DEPARTMENT, 5030 SUGARLOAF PARKWAY, LAWRENCEVILLE, GA, 30044, US

(21) Appl. No.: 09/908,942

(22) Filed: Jul. 19, 2001

(51) Int. Cl. H02H 1/00

(52) U.S. Cl. 361/119; 361/118

(57) ABSTRACT

In a communications system for transmitting and receiving forward and reverse signals, respectively, the communications system includes electrical devices for processing the forward and reverse signals and subscriber equipment for receiving the forward signals and for transmitting the reverse signals. The electrical device, for example, a distribution tap 300, includes an input port 310 for receiving the forward signals and transmitting the reverse signals, an output port 325 for transmitting the forward signals and receiving the reverse signals, and a plurality of subscriber ports 315a-n for provisioning a portion of the forward signals to subscriber equipment. Surge gap protection circuits 305 coupled to the input port 310 and to each of the plurality of subscriber ports 315a-n are included in the distribution tap 300 each for grounding a combination surge of at least 6 kV. The surge gap protection circuit 305 including a gap over which the combination surge arcs to ground.

### FIELD OF THE INVENTION

This invention relates generally to broadband communications systems, such as cable television systems, and more specifically to a protection circuit used in a distribution tap that is used in such systems.

### BACKGROUND OF THE INVENTION

A broadband communications system 100, such as a two-way hybrid/fiber coaxial (HFC) communications system, is depicted in FIG. 1. Such a system may be used in, for example, a cable television network; a voice delivery network, such as a telephone system; and a data delivery network to name but a few. The communications system 100 includes headend equipment 105 for generating forward signals (e.g., voice, video, or data signals) that are transmitted in the forward, or downstream, direction along a first communication medium, such as a fiber optic cable 110. Coupled to the headend 105 are optical nodes 115 that convert the optical signals to radio frequency (RF) signals. The RF signals are further transmitted along a second communication medium, such as coaxial cable 120, and are amplified, as necessary, by one or more distribution amplifiers 125 positioned along the communication medium. Taps 130 included in the communications system split off portions of the forward signals for provision to subscriber equipment 135, such as set-top terminals, computers, telephone handsets, modems, and televisions. It will be appreciated that only one fiber link connecting the headend 105 with a node 115 is shown for simplicity; however, there are typically several different fiber links connecting the headend 105 with several additional nodes 115, amplifiers 125, and subscriber equipment 135.

In a two-way system, the subscriber equipment 135 can also generate reverse electrical signals that are transmitted upstream to the headend equipment 105. Such reverse signals may be amplified by any one or more of the distribution amplifiers 125 and converted to optical signals by the optical node 115 before being provided to the headend equipment 105.

FIG. 2 is a block diagram of a conventional tap including a power distribution unit (PDU) that is suitable for use in the broadband communications system of FIG. 1. The tap 130 includes an input port 205 for receiving the forward signal and an output port 210 for passing the forward signal and for receiving a reverse signal from the communications system 100. A plurality of subscriber ports 215 directs portions of the forward signal to connected subscriber equipment. A tap 130 commonly includes two, four, or eight subscriber ports 215, although an even larger number of subscriber ports 215 can be included if necessary. A PDU 220 can also be included with the tap to supply power to a connected subscriber's premises. A plurality of power pins 225 connects, via coaxial cable or twisted pair cable, the PDU 220 with the subscriber.

Product specifications for the distribution taps 130 should withstand a typical combination, or ring wave, surge of voltage and current. Conventional tap circuitry is rated to withstand ten 1 kilo Volt (kV) surges before the potential of product failure. Combination surges, however, can easily surpass 1 kV. One example of a combination surge that affects the tap in a cable television system is a voltage surge along a power company's transmission power lines. Another example of a combination surge is a lightning strike that causes a voltage spike along the communication medium. Combination surges may occur anywhere throughout the communications system 100; therefore, if there is not adequate protection for the electrical and passive devices, e.g., the taps 130, this surge in power may affect the circuitry in the surrounding equipment.

In summary, electrical devices need to be designed and rated with greater importance given to mitigating the effects of combination surges. Thus, what is needed is a protection device for electrical devices, such as the distribution tap 130, that will limit the effects resulting from the combination voltage and current surges.

### BRIEF DESCRIPTION OF THE DRAWINGS

FIG. 1 is a block diagram of a conventional broadband communications system that carries analog optical and electrical signals.

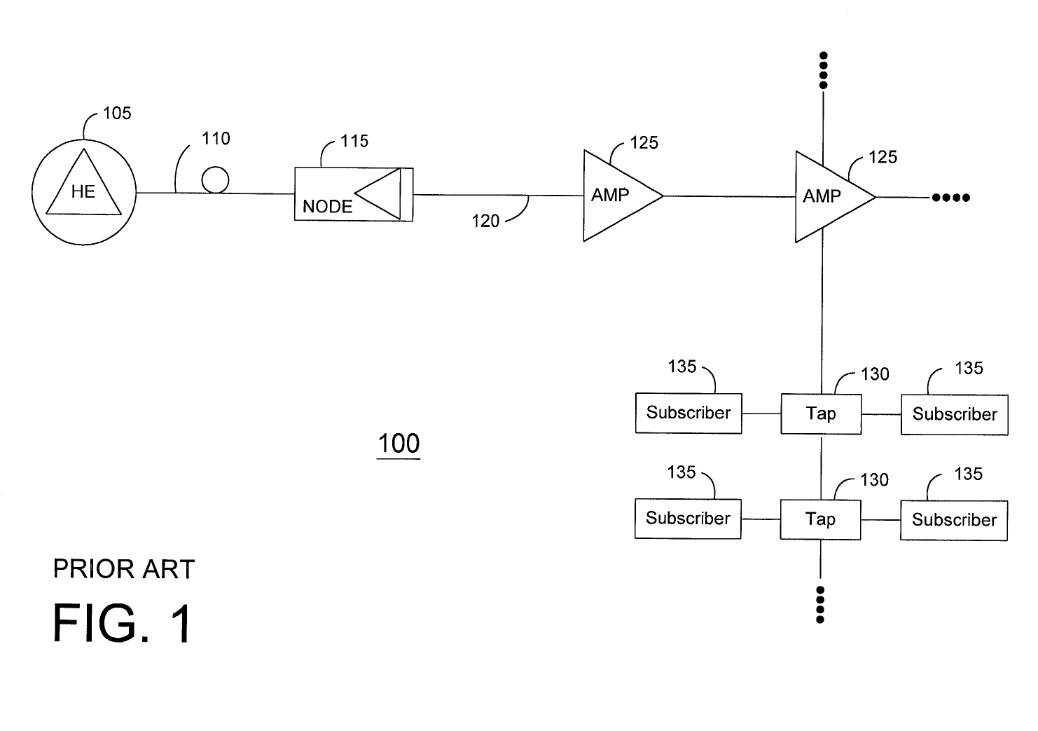

FIG. 2 is a block diagram of a conventional tap including a power distribution unit (PDU) that is suitable for use in the broadband communications system of FIG. 1.

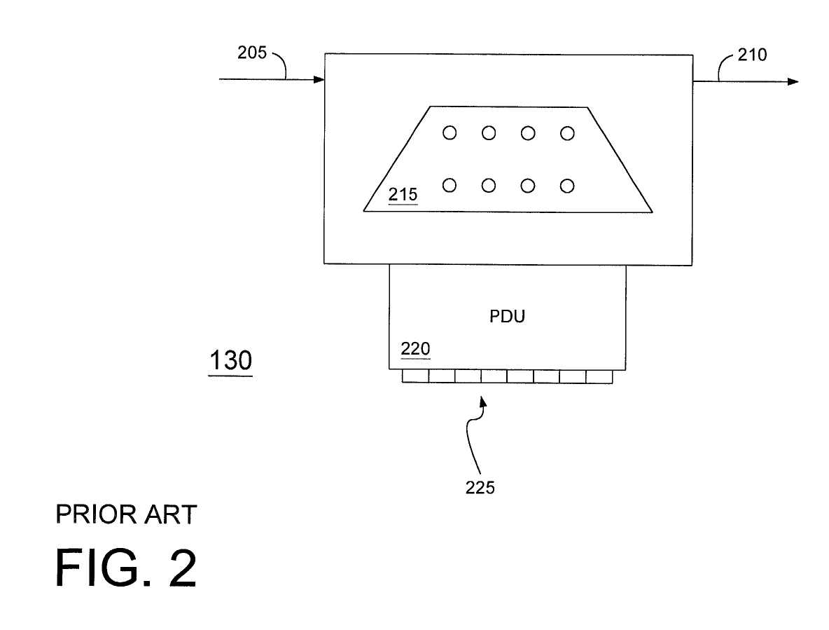

FIG. 3 is a block diagram of a distribution tap including surge gap protection circuits in accordance with the present invention.

FIG. 4 is a circuit diagram in accordance with the present invention illustrating each of the surge gap protection circuits of FIG. 3.

FIG. 5 is a schematic illustrating the components of the surge gap protection circuits of FIG. 4 assembled on a printed circuit board.

### DETAILED DESCRIPTION OF A PREFERRED EMBODIMENT

The present invention will be described more fully hereinafter with reference to the accompanying drawings in which like numerals represent like elements throughout the several figures, and in which an exemplary embodiment of the invention is shown. This invention may, however, be embodied in many different forms and should not be construed as limited to the embodiment set forth herein; rather, the embodiment is provided so that this disclosure will be thorough and complete, and will fully convey the scope of the invention to those skilled in the art. For example, the embodiment set forth herein refers to a circuit for protecting a distribution tap from a combination surge. The surge gap protection circuit, however, can be designed into many different types of electronic devices, such as a distribution tap including a power distribution unit (PDU), a cable equalizer, or an amplifier that are suitable for use in a broadband communications system. The present invention is described more fully hereinbelow.

As previously mentioned, combination surges can easily surpass 1 kV as a result of, for example, a lightning strike, thereby potentially causing components within the electrical device to fail. As a result, surge gap protection circuits in accordance with the present invention are included in distribution taps 130. Distribution taps with the protection circuits are now able to withstand a combination surge of at least up to ten 6 kV surges while continuing to pass 12 Amps (A) of current through the tap 130 or 350 mA per subscriber port. It will be appreciated that the surge gap protection circuits can be included in other electrical devices. Advantageously, this increase in electrical specification is significant in allowing a longer life for the electrical device in which they protect.

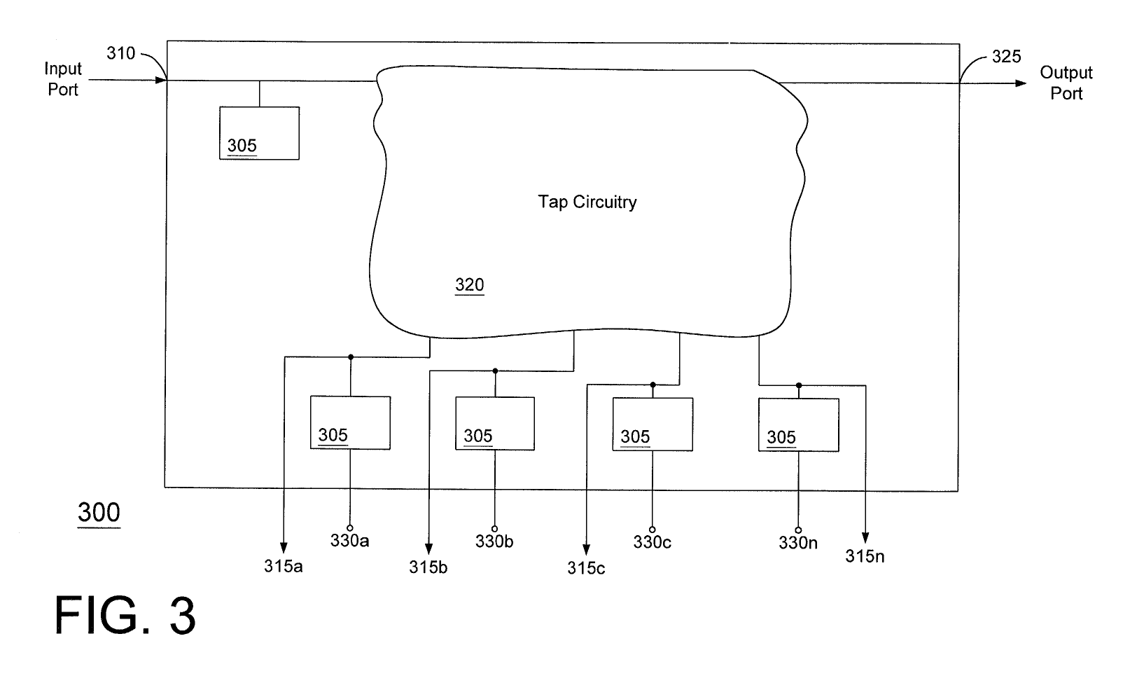

FIG. 3 is a block diagram of a distribution tap 300 including surge gap protection circuits 305 in accordance with the present invention. For adequate protection, a surge gap protection circuit 305 is located at the input port 310 and at all the subscriber output ports 315a-n. It will be appreciated that the surge gap circuits 305 are placed in the tap circuitry prior to a surge reaching the conventional tap circuit 320. More specifically, a surge gap circuit 305 is placed at the input port 310 to protect from a forward surge and at each of the subscriber output ports 315a-n to protect from a reverse surge. Output port 325 is protected by the same surge gap protection circuit 305 as the input port 310. When the tap 300 includes a PDU, power pins 330a-n are included. The surge gap circuit 305 is then placed between the subscriber output port 315a-n and the power pins 330a-n.

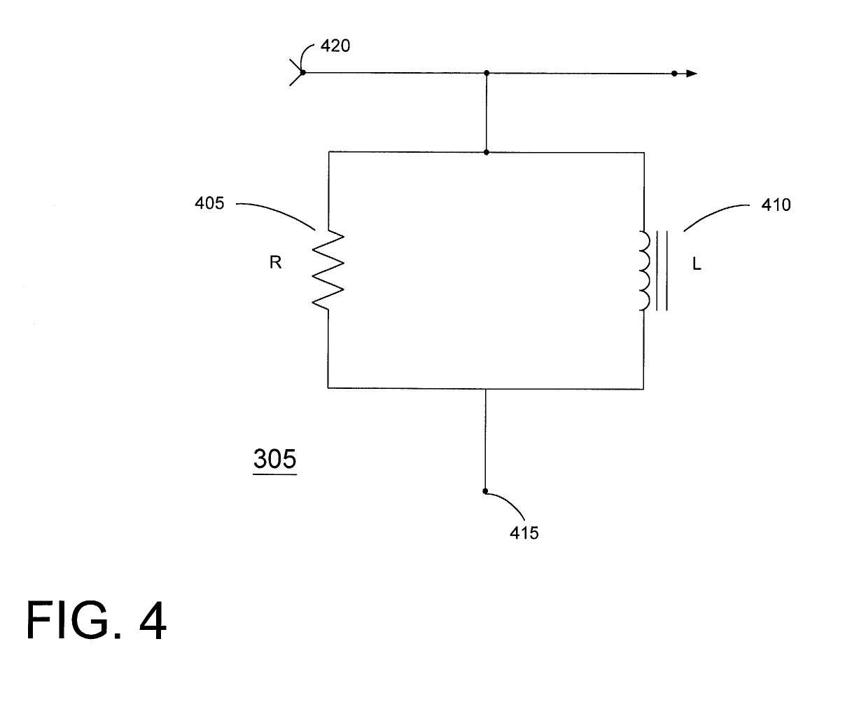

FIG. 4 is a circuit diagram illustrating each of the surge gap protection circuits 305 of FIG. 3. Though only one circuit 305 is shown for simplicity, it will be appreciated that each of the circuits 305 are designed using the same components in the same manner with only the specific values of the components changing. The surge gap circuits 305 each include a resistor 405 in parallel with a transformer coil 410, which has an inductance value. Both components 405, 410 are then connected to a ground pin 415. Alternatively, when the surge gap protection circuits 305 are used in a distribution tap that includes a PDU, each of the surge gap protection circuits 305 are grounded to the power pin 330a-n. The surge gap circuits 305 are filtration circuits that allow a least resistance path to ground for the power surge. It will be appreciated that the resistance and inductance values of the components 405, 410 are dependent upon the design of the electronic device in which they are installed and the values can be modified to still meet the specification of withstanding a minimum combination rating of 6 kV. By way of example, a resistor value of 1.2 kilo ohms and a 20.5 turn transformer coil can be used at the input port 420 (310 FIG. 3). At each of the subscriber output ports 420 (315a-n FIG. 3), a 4.7 kilo ohms resistor can be used instead of the 1.2 kilo ohms resistor.

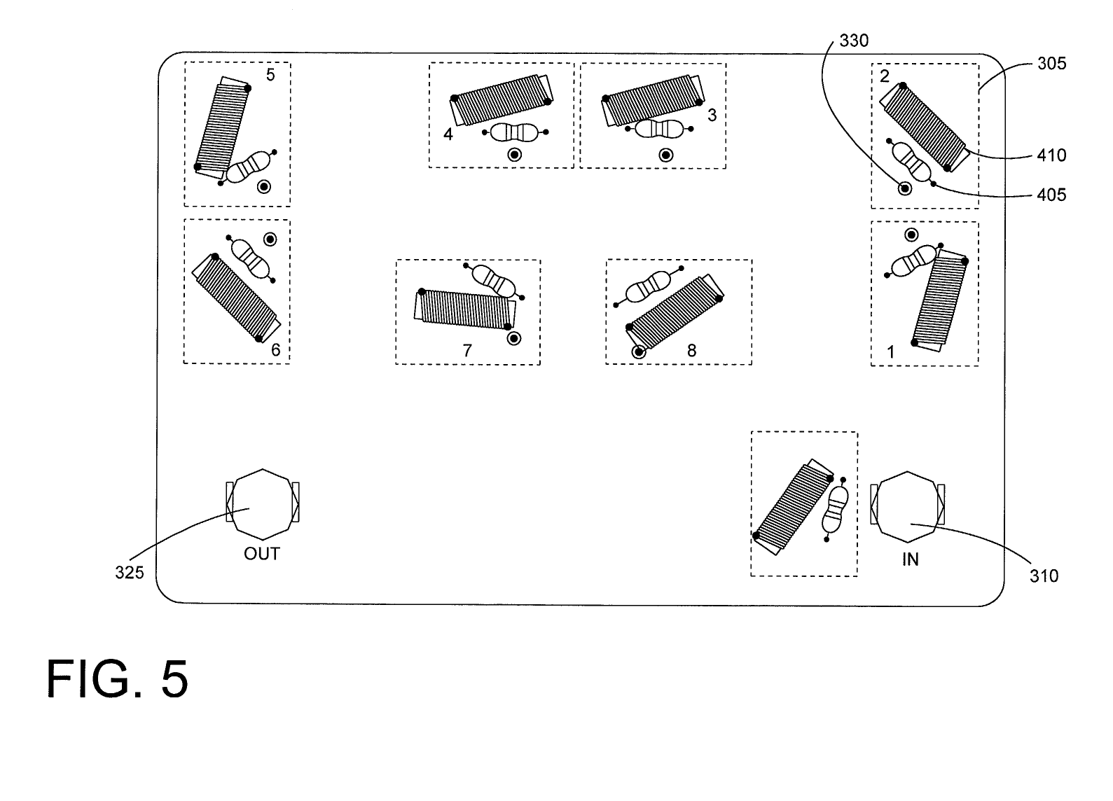

FIG. 5 is a schematic illustrating the components 405, 410 of the surge gap protection circuits 305 of FIG. 4 assembled on a printed circuit board (pcb). The schematic illustrates the position of the resistor 405, the coil 410, and the power pin 330 (when used) for each circuit 305. The illustration represents an eight port subscriber tap; therefore, eight surge gap protection circuits 305 are assembled on the pcb protecting each of the eight subscriber ports (not shown). The position of the resistor 405 and coil 410 for each circuit 305 is chosen to direct an arc to a specific location on the pcb in the event of a combination surge. In the preferred embodiment of the present invention, the direction of the coil 410 relative to exposed masking (not shown) on the pcb allows the surge to arc over a gap from the components 405, 410 to the exposed masking. The exposed masking is then either grounded to a ground plane in the pcb or to the power pin 330a-n. Advantageously, the arc is directed away from any other components located on the pcb. Additionally, the length of the gap between the coil 410 and the exposed masking is less than the length between any other components on the pcb. For example, in the preferred embodiment, a length of no greater than 50 milli meters (mm) is used for the gap between the coil and the exposed masking. All remaining lengths between components on the pcb are greater than 50 mm, thereby ensuring the surge gap between the coil 410 and ground is the path of least resistance.

In summary, the preferred embodiment of the present invention illustrates a surge gap protection circuit 305 that can be designed into an electrical device, e.g., a distribution tap 300, to protect the internal components from a surge of at least 6 kV. In this manner, protective circuitry may extend the life of the device in the event of a combination surge.

What is claimed is:

1. In a communications system for transmitting and receiving forward and reverse signals, respectively, the communications system including electrical devices for processing the forward and reverse signals and subscriber equipment for receiving the forward signals and for transmitting the reverse signals, an electrical device comprising:
an input port for receiving the forward signals and transmitting the reverse signals;
an output port for transmitting the forward signals and receiving the reverse signals;
a plurality of subscriber ports for provisioning a portion of the forward signals to subscriber equipment; and
a plurality of surge gap protection circuits, wherein a surge gap protection circuit is coupled to the input port and at each of the plurality of subscriber ports, each of the plurality of surge gap protection circuits for grounding a combination surge.

2. The communications system of claim 1, wherein each of the plurality of surge gap protection circuits protects the electrical device from at least a 6 kV combination surge.

3. The communications system of claim 1, each of the plurality of surge gap protection circuits comprising:
a resistor;
a coil in parallel with the resistor; and
a ground pin,
wherein, in the event of the combination surge, a resulting arc is directed over a gap to the ground pin, wherein the gap having a predetermined length is from the coil to exposed masking on a printed circuit board, and wherein the exposed masking is coupled to the ground pin.

4. The communications system of claim 1, wherein the electrical device is a distribution tap.

5. A distribution tap including a power distribution unit, comprising:
an input port for receiving signals;
a first surge gap protection circuit coupled to the input port for providing a path to ground in the event of a combination surge;
tap circuitry coupled to the first surge gap protection circuit for processing the signals;
a plurality of subscriber ports coupled to the tap circuitry for providing a portion of the signals to subscriber equipment;
a plurality of power ports coupled to the tap circuitry for providing power to subscriber equipment;
a plurality of surge gap protection circuits, wherein a surge gap protection circuit is coupled between the each of the plurality of subscriber ports and each of the plurality of power pins each for providing a path to the plurality of power pins in the event of a combination surge.

6. The distribution tap of claim 5, wherein each of the plurality of surge gap protection circuits protects the distribution tap from at least a 6 kV combination surge.

7. The distribution tap of claim 5, wherein each of plurality of the surge gap protection circuits comprises:
a resistor;
a coil in parallel with the resistor; and
a ground pin,
wherein, in the event of the combination surge, a resulting arc is directed over a gap to the ground pin, wherein the gap having a predetermined length is from the coil to exposed masking on a printed circuit board, and wherein the exposed masking is coupled to the ground pin.

8. The distribution tap of claim 7, wherein the ground pin associated with each of the plurality of surge gap protection circuits is one of the plurality of power ports.

9. In a distribution tap including an input port and an output port for transmitting and receiving signals, the distribution tap for providing a portion of the signals to subscriber equipment via a plurality of subscriber output ports, a method for protecting the distribution tap from a surge, the steps comprising of:
receiving the surge in any one of the input port, the output port, and the plurality of subscriber output ports; and
directing, by way of an electrical circuit coupled to each of the input port and the plurality of subscriber output ports, the surge over a gap from the electrical circuit to exposed masking on a printed circuit board, wherein the exposed masking is coupled to a ground plane.
